(19) United States
(12) Patent Application Publication
(10) Pub. No.: US 2011/0069944 A1
(43) Pub. Date: Mar. 24, 2011

(54) PORTABLE PHOTO BOOTH

(75) Inventor: Elizabeth Johnson, Indianapolis, IN (US)

(73) Assignee: FISH FACE PHOTO BOOTHS, LLC, Indianapolis, IN (US)

(21) Appl. No.: 12/885,446

(22) Filed: Sep. 18, 2010

Related U.S. Application Data
(60) Provisional application No. 61/244,382, filed on Sep. 21, 2009.

(51) Int. Cl. G03B 15/00

(52) U.S. Cl. 396/2

(57) ABSTRACT

A portable photo booth is provided which can be temporarily located at live events and popular places. The photo booth is relatively lightweight and includes wheels and a lift system that raises and lowers the photo booth relative to the wheels. When lowered, the booth is supported on bumper feet to remain stationary at the temporary location. The photo booth includes an on-board computer and wireless communication feature to facilitate payment and uploading of photos by the customer.

### REFERENCE TO RELATED APPLICATION

This application claims priority to co-pending provisional application No. 61/244,382, filed on Sep. 21, 2010, the entire disclosure of which is incorporated herein by reference.

### BACKGROUND

Photo booths in shopping malls are well-known. The typical mall photo booth is shipped in, placed by forklift, and fastened to the floor. On problem with is that the booth is inherently in a fixed location and is not necessarily located “where the action is,” namely at live events.

Live events, such as weddings, corporate events, proms, reunions, bar/bat-mitzvahs, birthdays, parties and the like are rife with photo opportunities. The guests or participants are usually desirous of memorializing the event. Some events may have a professional photographer roaming the event, or disposable cameras may be provided. The professional photographer is often expensive, and guests are not always adept at taking their own pictures. There is a need for providing access to inexpensive, easy-to-use professional grade photography at these live events. The need may also translate to other locations where people congregate, such as at bars, restaurants, parks, museums, and other locations.

### SUMMARY

In order to address these needs, a portable photo booth is provided which can be temporarily located at live events and popular places. To facilitate portability the photo booth will be moveable by one person without the need for a forklift or dolly. Thus, the photo booth is relatively lightweight and includes wheels. In one embodiment, the frame of the photo booth may be made of 11 gage square steel tube weighing less than a total of 700 pounds. In another embodiment, the photo booth may include swivel caster wheels to improve maneuverability and control. In another embodiment, the corners of the photo booth are mitered to allow for a three inch radius outside the corners for increased clearance during navigation and transportation of the photo booth, especially in tight spaces.

A lift system is provided that can lift the frame of the photo booth, leaving the wheels in engagement with the ground, so that the photo booth can be rolled. The lift system can then lower the frame so that it rests on bumper feet, once the booth has been transported to it temporary location.

The portable photo booth incorporates a computer to control the photography and payment. The computer communicates through a wireless network to effective credit or debit card payment. Moreover, the wireless communication allows the customer to upload the photos to a web page for later access.

### BRIEF DESCRIPTION OF THE DRAWINGS

FIG. 1 is a perspective view of a photo booth described herein;

FIGS. 2a and 2b are perspective views of a collapsible photo booth before and after being collapsed;

FIG. 3 is a perspective view of a photo booth showing electrical and mechanical components;

FIG. 4 is a perspective view of a lift system for the photo booth;

FIG. 5a is a side view of a lift system for the photo booth in its stationary position;

FIG. 5b is a side view of a lift system for the photo booth in its moveable position; and

FIG. 6 is a top view of a lift system for the photo booth.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

The present invention contemplates a portable photo booth which can be temporarily located at live events and popular places. To facilitate portability the photo booth will be moveable by one person without the need for a forklift or dolly. Thus, the photo booth is relatively lightweight and includes wheels. In one embodiment, the frame of the photo booth may be made of 11 gage square steel tube weighing less than a total of 700 pounds. In another embodiment, the photo booth may include swivel caster wheels to improve maneuverability and control. In another embodiment, the corners of the photo booth are mitered to allow for a three inch radius outside the corners for increased clearance during navigation and transportation of the photo booth, especially in tight spaces.

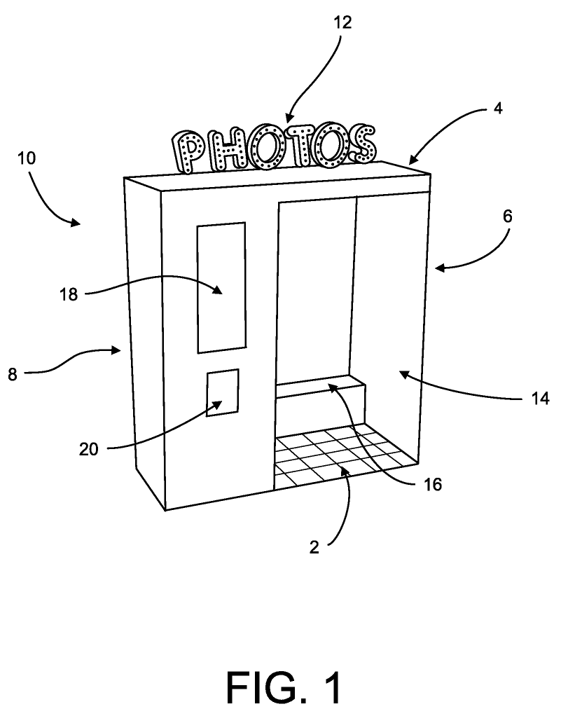

Referring to FIG. 1, an embodiment of a portable photo booth 10 is depicted. As illustrated, the frame of the portable photo booth 10 includes an inside floor 2, a top 4, a seating side wall 6, and a camera side wall 8. The opening between the seating side wall 6 and the camera side wall 8 is handicap accessible. A top sign 12 may be affixed to the top 4 of the photo booth 10 to provide an aesthetically pleasing and inviting appearance. A folding bench type seat 14 is attached to the seating side wall 6 of the photo booth 10 to provide seating for customers while they are being photographed. This seat 14 is configured to fold toward the seating side wall 6 to allow for more space within the photo booth 10 when necessary, such as when the customers wish to stand for their photo. This seat 14 may be sized so that a minimum of two people can sit side by side while being photographed. The photo booth 10 includes a draw curtain 16 which is attached to the top 4 and hangs down between the seating side wall 6 and the camera side wall 8. This draw curtain 16 can be pushed open while customers are entering and exiting the photo booth 10 or it can be pulled across to cover the opening between seating side wall 6 and camera side wall 8 to provide privacy and better photograph conditions. In one embodiment, draw curtains 16 may be attached on opposite sides of the photo booth 10 so that customers may enter or exit from both sides. The photo booth 10 may further include an outside mirror 18 attached to the exterior of the photo booth 10 which customers can use in preparation for their photographs. The photo booth 10 further includes a photo dispensing shelf 20 from which customers can retrieve printed photographs.

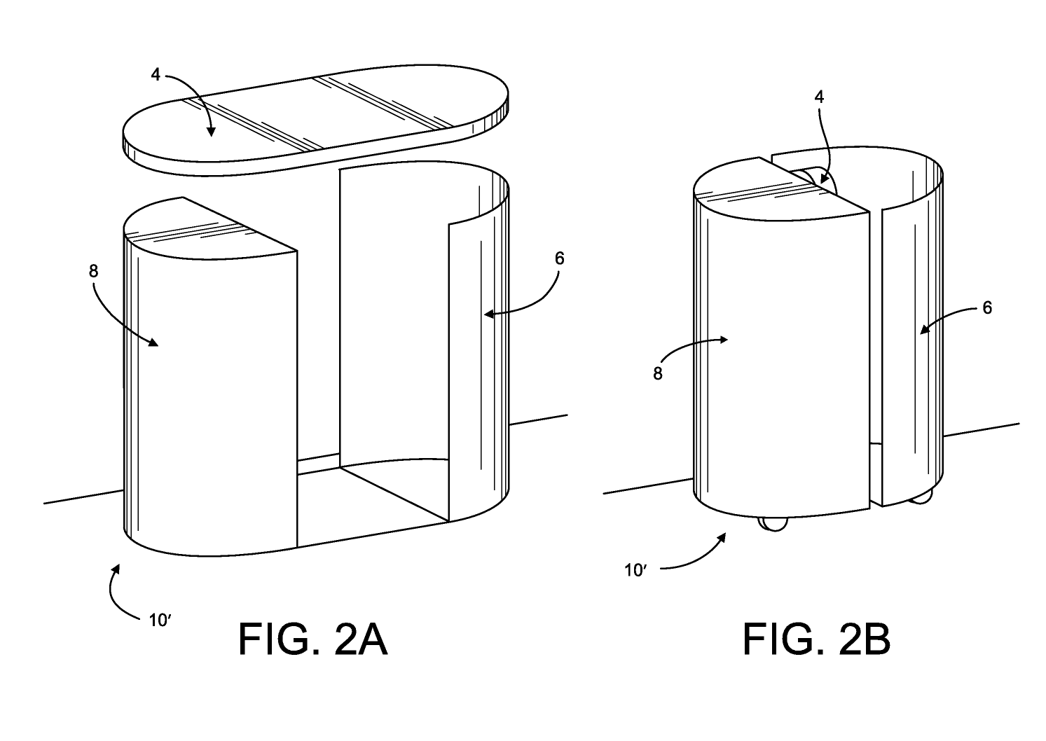

As shown in FIGS. 2a and 2b, a modified photo booth 10′ in one embodiment may be collapsed for transportation. The top 4 of the photo booth 10′ can be removed, as shown in FIG. 2a, and stored within the photo booth 10′. The seating side wall 6 and the camera side wall 8 of the photo booth 10′ can then be pushed toward one another to compress the photo booth into a smaller unit as shown in FIG. 2b.

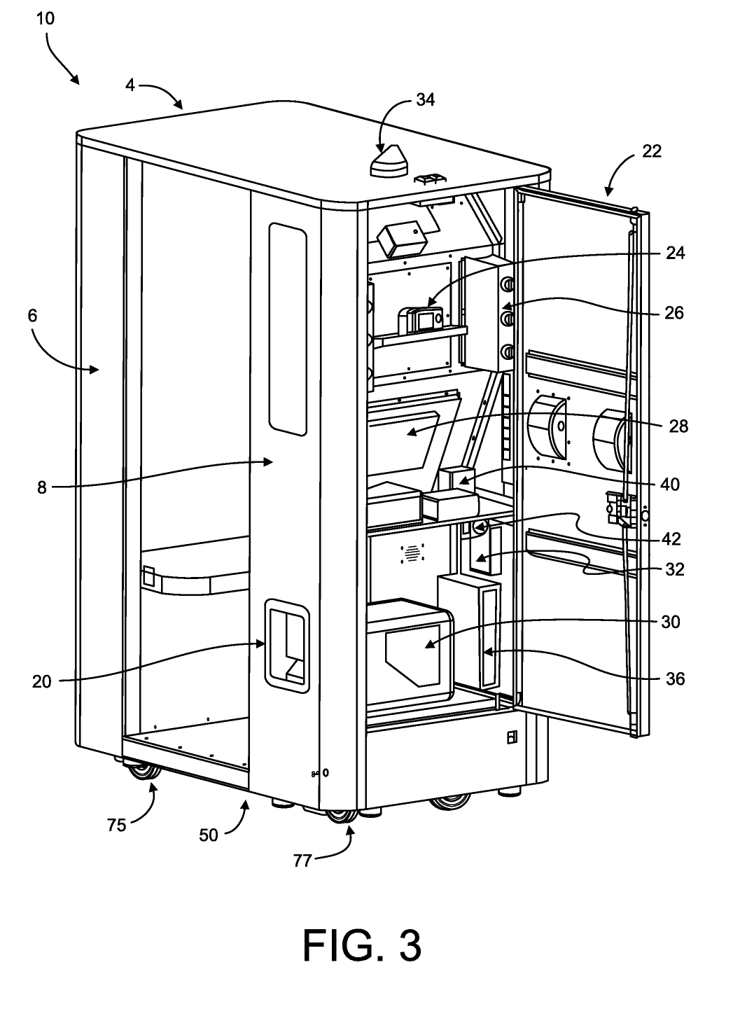

FIG. 3 depicts the including the mechanical and electrical features of the portable photo booth 10 which capture the photo images, process information about the photo images, produce photo prints and receive payment for photos. These mechanical and electrical features are located within the camera side wall 8 and are accessible through a lockable door 22 which preferably opens to the exterior of the photo booth 10. These features include a camera 24 for capturing the photo images. The camera 24 is attached within the camera side wall 8 and can be accessed through the lockable door 22. The lens of the camera 24 points toward the seating side wall 6 of the photo booth 10 through a lens opening (not shown) in the camera side wall 8. A flash array 26 or other illumination feature is also attached within the camera side wall 8 and accessible through lockable door 22. The bulbs of the flash array 26 may shine through bulb openings (not shown) directed toward the seating side wall 6 of the photo booth 10 to provide lighting while the photo image is being captured by the camera 24.

A display monitor 28 is also attached within the camera side wall 8 and accessible through lockable door 22. The screen of the display monitor 28 is visible inside the photo booth through a screen opening (not shown) and may be used by customers while they are seated within the photo booth 10. The monitor 28 may incorporate a touch screen feature that allows the customer to enter information directly through the monitor, without the need for a data entry keypad. A printer 30 is attached within the camera side wall 8 for transferring the photo image onto photo paper for customers and dispensing the finished printed photos into the dispensing shelf 20. A credit card reader (not shown) is also attached within the camera side wall 8 and is accessible by customers while they are seated within the photo booth 10 so that they may pay for photos. A communications box 32 which receives payment information is attached within the camera side wall 8 and is linked to an antenna 34 attached to the top 4 of the photo booth 10 for wireless transmission of information from the communications box 32.

A computer 36 is configured to send and receive information to control the camera 24, flash array 26, display monitor 28, credit card reader (not shown), printer 30, communications box 32 and antenna 34. The computer 36 is attached within the computer side wall 8 and is accessible through lockable door 22 and is not accessible to customers. When customers enter the photo booth 10 to take a photograph, they use the display monitor 28 to make selections from options menus displayed on the screen under control by the computer. Options can include, for example, the number of photos printed, the size of photos printed, the customization of logos, colors, backgrounds or borders, whether photos are color or black and white, whether video feed will be recorded and whether the photos are to be uploaded to a web page or the Internet. The computer 36 will receive and process photo information from the display monitor 28 and control the camera 24 and flash array 26 accordingly. When a customer pays for the photos using the credit card reader (not shown), the computer 36 will receive and process this information and control the communications box 32 and antenna 34 accordingly. After a customer has been photographed and paid for printed photographs, the computer 36 will control the printer 30 accordingly.

The computer 36 may also be equipped with software programmed such that it will record, for example, the location of the photo booth 10, the number of photos taken, the method of payment, the options selected by each customer, the amount of photo paper remaining, the amount of vending sales, any errors that have occurred or maintenance that needs to be performed. This information can be later retrieved by the operator or owner of the photo booth 10 so that he or she may make appropriate adjustments. In one embodiment, the computer 36 is configured to transmit information to the World Wide Web so that photo images may be accessed through a webpage on the internet. Thus, the photo booth 10, through its computer, may constantly transmit information to the proprietor or manager of the booth indicative of the status and health of the booth. The booth proprietor may then receive advance notice when maintenance issues arise.

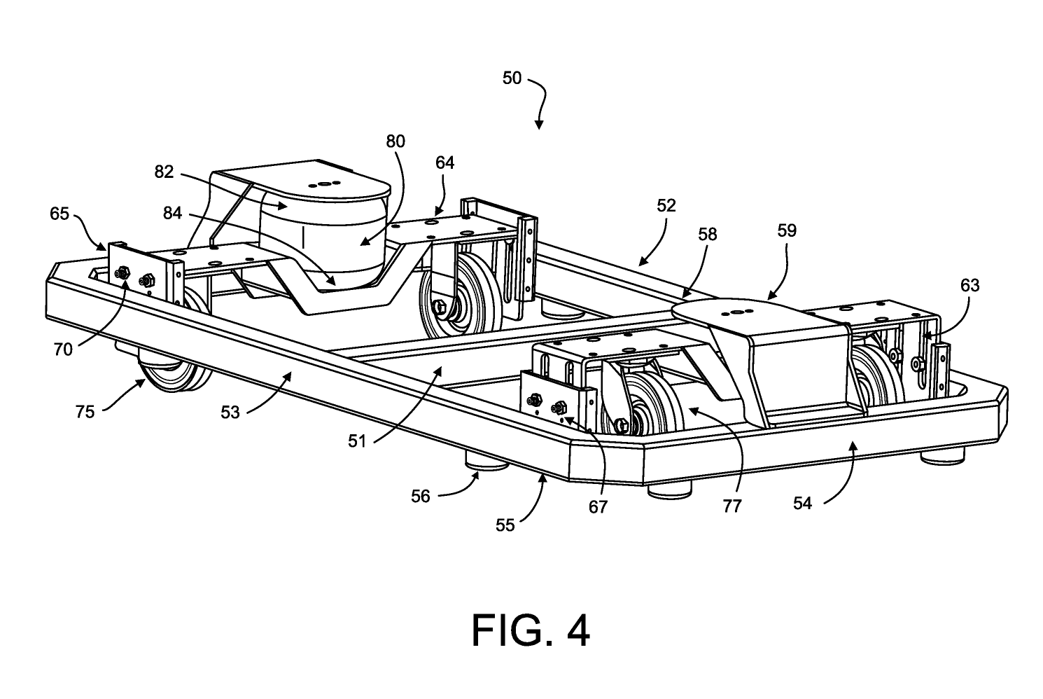

Also accessible through the lockable door 22 are a power supply 40 and an air control switch 42. These features are used to operate a lift system 50 attached to the bottom of the photo booth 10, as described below. The compressor battery 40 operates an air compressor (not shown) which either fills or empties an air lift bag 80, shown in FIG. 4, to raise or lower the photo booth 10. The control switch 42 may incorporate a safety interlock that prevents activation of the lift system 50 when the photo booth 10 is occupied or in use. In an alternative embodiment, a foot pump (not shown) may be used instead of an electrical air compressor to fill or empty the air lift bags 80. As explained in detail below, raising the photo booth 10 allows the wheels 75, 77 under the bottom of the photo booth, shown in FIG. 4, to move freely which thus renders the photo booth 10 movable.

The power supply 40 is a remote power supply, such as a battery. The remote power supply thus complements the portability of the photo booth 10 since no electrical connection to a separate power source is required. The power supply may be rechargeable or may incorporate the capability to tap into a separate power source.

FIG. 4 depicts the lift system 50 which allows the photo booth 10 to be easily transported to and from event venues and popular places. The lift system 50 is attached to the bottom of the photo booth 10 and alternatively acts as either a stationary or moveable base. The lift system 50 includes a bottom frame 52 which is affixed to the bottom of the photo booth 10, such as by attaching the seating side wall 6 and the camera side wall 8 to bottom frame 52 in a suitable manner. The inside floor 2, the seating side wall 6 and the camera side wall 8, including the mechanical and electrical components within camera side wall 8, may be supported on and mounted to the top surface 58 of the bottom frame 52. The bottom frame 52 may also include a cross bar member 51 for added support for the photo booth 10 and improved structural stability.

The bottom frame 52 may be rectangular in shape with two longer sides 53 and two shorter sides 54. The shorter sides 54 are sized to fit through standard door openings and the entire photo booth 10 is sized to fit inside an average elevator. The shorter sides 54 may support the seating side wall 6 and the camera side wall 8. As shown in FIG. 4, the corners of the frame may be mitered or angled to avoid sharp corners that may impede passage of the photo booth through a doorway, for instance. The longer sides 53 may then provide a handicap accessible space for customers to enter and exit the photo booth 10. Bumper feet 56 protrude from the bottom surface 55 of the bottom frame 52 and provide sturdy, non-slip contact points between the lift system 50 and the ground to stably support the photo booth 10. To further facilitate handicap accessibility, the bottom frame 52 may be beveled along the longer sides 53 to minimize the height of the edge between the ground and the inside floor 2, or incorporate a ramp that is deployable from the bottom frame.

The lift system 50 includes wheels 75, 77 for transporting the photo booth 10. The wheels 75, 77 will have a width and radius such that they will not become easily stuck on cracks, bumps, uneven surfaces or doorways when the photo booth 10 is being rolled from one location to another. In one embodiment, the wheels are Colson caster wheels with a six inch diameter.

The lift system 50 includes wheel mount brackets 65 affixed near each end of the two longer sides 53 of the bottom frame 52. The lift system 50 also includes two wheel supports 64 which hold the wheels 75, 77 in place. A set of two fixed wheels 75 may be attached to the bottom of one of the wheel support 64. A set of two caster wheels 77 may be attached to the bottom of the other wheel support 64. The wheel mount brackets 65 and the wheel supports 64 are configured to work cooperatively, as described below, such that the wheels 75, 77 are vertically slideable relative to the bottom frame 52.

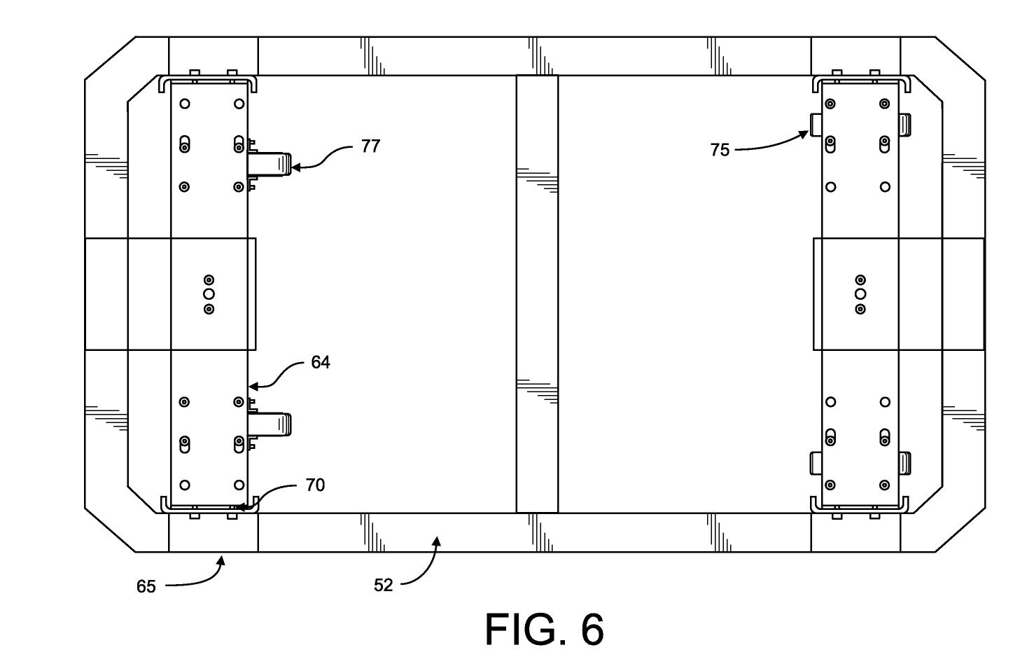

Each wheel support 64 includes slots 63 for receiving sliding posts 70 that are mounted in holes 67 of the wheel mount bracket 65. Thus, as shown in FIG. 6, the sliding posts 70 slideably connect the wheel supports 64 to the wheel mount brackets 65. In one embodiment, the sliding posts 70 are guided and captured through the sliding slots 63 with Oilite® guide bushings and washers. The wheel supports 64 are able to slide vertically in relation to the wheel mount brackets 65, thus the wheels 75, 77 are able to slide vertically in relation to the bottom frame 52. In one embodiment, the surface areas of wheel mount bracket 65 which may come in contact with wheel support 64 while the photo booth 10 is being transported are covered by a Delrin® or nylon guide block to prevent wear and sticking.

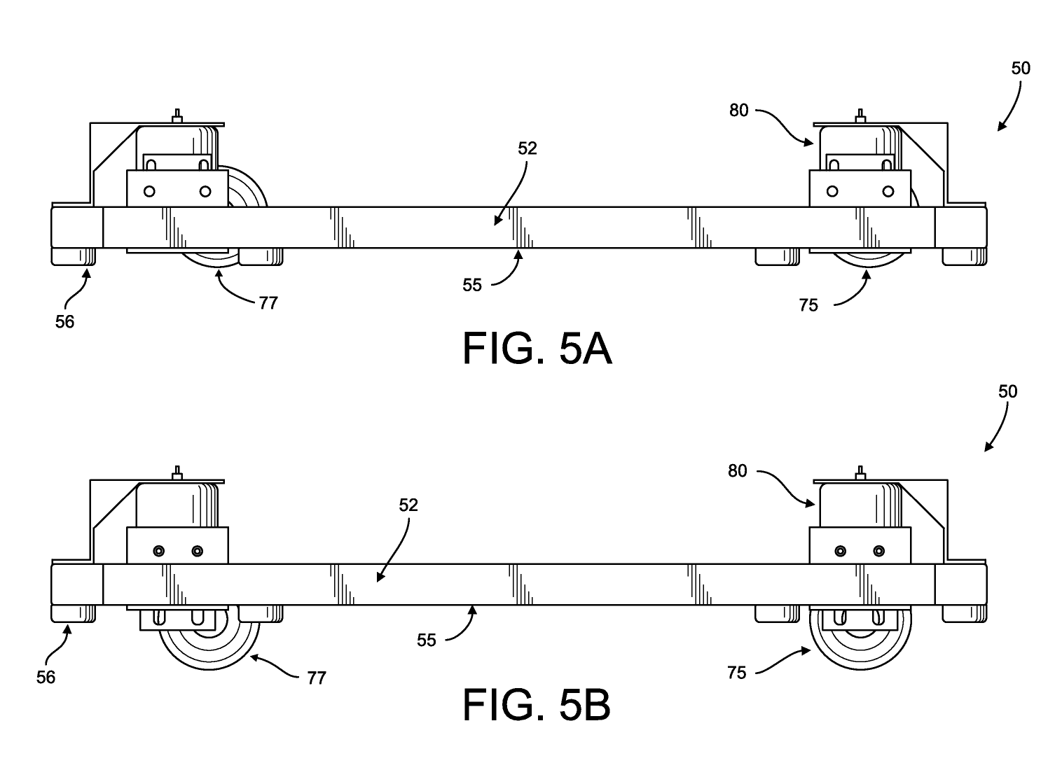

When the photo booth 10 is stationary or in use, the bumper feet 56 are resting on the ground. As shown in FIG. 5a, the bumper feet extend further than the wheels 75, 77 relative to the bottom surface 55 of the bottom frame 52. Alternatively, in order to transport the photo booth 10, the wheels 75, 77 are extended below the photo booth 10 so that they may freely roll when the photo booth 10 is pushed or pulled. To allow the photo booth 10 to roll, the wheels 75, 77 must extend further than the bumper feet 56 relative to the bottom surface 55 of the bottom frame 52. This position is depicted in FIG. 5b. In a specific embodiment, the lift system elevates the frame so that the bumper feet are at least one inch off the ground.

Referring back to FIG. 4, a top mount bracket 59 is affixed to top surface 58 of the bottom frame 52 at the center of each of the shorter sides 54 of the bottom frame 52. These top mount brackets 59 remain in a fixed position relative to the bottom frame 52. Two air lift bags 80 are filled or emptied by an air compressor (not shown) when the air control switch 42 is activated. The air compressor may be mounted in a suitable position on the frame 53 or within the housing of the photo booth 10. The bag top 82 of each air lift bag 80 is attached to a top mount bracket 59 while the bag bottom 84 is attached to a wheel support 64. Thus the air lift bag 80 connects the top mount bracket 59 to the wheel support 64. As described below in more detail, to transform the lift system 50 from a stationary base, as shown in FIG. 5a, to a moveable base, as shown in FIG. 5b, the air compressor forces air through a connecting air tube (not shown) to fill the air lift bag 80 which in effect raises the bottom frame 52 relative to the wheels 75, 77 (although initially the wheels may be lowered until the contact the floor). Conversely, to return the lift system 50 to a stationary base, the air compressor releases air through the air tube to empty the air lift bags 80 which in effect lowers the frame relative to the wheels until the bumper feet contact the ground. Once the bumper feet fully support the photo booth, further deflation of the air lift bags may raise the wheels 75, 77 relative to the bottom frame 52.

When the air lift bags 80 are inflated, they expand, and as a result, the distance between the top mount brackets 59 and the wheel supports 64 increases. Thus the inflated bags may initially push the wheels 75, 77 down until they contact the ground. Once the wheels contact the floor or ground, further inflation of the air lift bags 80 will push the top mount brackets 59 up, which carries the bottom frame 52 with them. Because the wheel mount brackets 65 are fixedly attached to the bottom frame 52, the wheel mount brackets 65 thus slide upward relative to the wheel supports 64 as the sliding posts 70 slide within the sliding slots 63. Once the air lift bag 80 is fully inflated, the bottom frame 52 will be effectively lifted relative to the wheel support 64 and the wheels 75, 77, allowing for the photo booth 10 to be transported by rolling as shown in FIG. 5b.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A portable photo booth comprising:
a first wall, with a seating bench attached thereto configured to provide seating for at least one customer;
a second wall supporting a camera and electrical equipment configured for accepting and processing payment by the customer and for controlling the camera to generate a photograph of the customer within the photo booth;
a bottom frame, said bottom frame supporting said first wall and said second wall; and
a lift system including:
a mounting bracket arrangement attached to said bottom frame;
a wheel support bar slidably supported by said bottom frame;
a plurality of ground-engaging wheels carried by said wheel support bar; and
an air bag system disposed between said mounting bracket arrangement and said wheel support arrangement, said air bag system configured when deflated to move said bottom frame into ground engagement to provide a stationary base for the photo booth and when inflated to move said wheels into ground engagement to provide a moveable base for the photo booth.

2. The photo booth of claim 1, wherein said wheel support bar includes a top side and a bottom side, said air bag being located on said top side of said wheel support bar and said extendable wheels being located on said bottom side of said wheel support bar.

3. The photo booth of claim 1, wherein said lift system includes an electric air compressor for inflating said air bag system.

4. The photo booth of claim 3, wherein said lift system includes a mechanical foot pump for inflating said air bag system.

5. The photo booth of claim 1, wherein said plurality of ground-engaging wheels includes at least two swivel caster wheels.

6. The photo booth of claim 1, wherein said bottom frame includes non-slip ground-engaging feet.

7. The photo booth of claim 1, wherein said seating bench is hingedly attached to said first wall.

8. The photo booth of claim 1, wherein said first wall and said second wall are slideably attached to said bottom frame.

9. The photo booth of claim 1, wherein said electrical equipment includes a computer and an antenna connected to said computer for wireless transmission of information therefrom.

10. The photo booth of claim 9, wherein said electrical equipment further includes a card reader configured for accepting payment by a credit or debit card.

11. The photo booth of claim 9, wherein said electrical equipment further includes a touch screen display communicating with said computer and configured for data entry by the customer.

12. The photo booth of claim 9, wherein said electrical equipment includes a remote power supply.
